(19) United States
(12) Patent Application Publication
(10) Pub. No.: US 2011/0025153 A1
(43) Pub. Date: Feb. 3, 2011

(54) optimised levitation device

(76) Inventor: Jannick SIMERAY, Hong Kong (HK)

Correspondence Address: Jannick Simeray, Unit 802, Tower B, New Mandarin Plaza, TST East, Kowloon, HK

(21) Appl. No.: 12/618,775

(22) Filed: Nov. 15, 2009

Related U.S. Application Data
(60) Provisional application No. 61/115,092, filed on Nov. 16, 2008.

(51) Int. Cl. H02K 7/09

(52) U.S. Cl. 310/90.5

(57) ABSTRACT

Device for levitation of an item over an optimized base by means of permanent magnets. The equilibrium is stable along one or two axes by means of these permanent magnets, and along the one or two others by means of a combination of electromagnets of near zero consumption at equilibrium.

### FIELD OF THE INVENTION

The invention relates to the principle and the realization of a magnetic levitation device for various items, without overturn of said device.

This device is applicable to items of decoration, advertising communication, or with industrial applications that require the levitation of an item.

### BACKGROUND INFORMATION

The state of the art for levitation devices comprises items in magnetic lift such as to globes. These devices comprise a magnet at their top (at the North Pole for a globe) and are suspended under a magnet; wherein an electromagnet controls the levitating objects attraction in order to maintain a constant distance between item and the holder. These conventional systems control the electromagnet through the measurement of the magnetic field produced by the item at the level of the holder. The field at the level of the holder is measured by means of a Hall Effect sensor that delivers a tension proportional to the measured magnetic field.

The PCT IB 2006004040 from the same inventor describes a way to realised levitation according to this specification:
the levitating item is not suspended under a magnetic device but levitates over a base that comprises sources for the magnetic field.
the levitating item can be heavy. The levitation process is also completely quiet. The surface above which the item levitates is flat or at least regular. The space between the surface and the item is free and empty of any device. The arrangement implemented for the levitation is discreet or even not perceivable. The levitating item is also stable concerning turn-over.
the levitating item is in rotation around the vertical or tilted axis, free or maintained. The levitation consumes little energy, or is permanent or at least autonomous (i.e. power supply independent) over a long time duration.

The industrial application of this patent present defects and over cost that:
Forbid to operate this invention in the mass market for decoration and toy.
Forbid to operate it for large dimensions for art; industry and advertisement.

The main defects are:
the weight of the base, the weight of the levitated magnet and the thickness of the base.
the power requested to set up the levitated item and the average power requested for permanent rotation of the levitating item.

And as a consequence of all this, the cost of this solution is affected by the cost of the base magnet; of the levitated magnet; and of the power supply.

The operation of the invention PCT IB 2006004040 of the same inventor demonstrates the following characteristics for some example of dimensions:

| | | | | | | | | | | for | for |
|---|---|---|---|---|---|---|---|---|---|---|---|
| | | | | | base | globe | Levitated | set up | set up | turning | turning |
| D | | | | | weight | size | weight | one axe | 2 axes | one axe | 2 axes |
| mm | d | E | E′ | h | g | mm | g | W | W | W | W |
| 90 | 45 | 20 | 40 | 25 | 800 | 100 | 60 | 12 | 18 | 4 | 5 |
| 120 | 60 | 25 | 40 | 30 | 1600 | 140 | 120 | 18 | 27 | 4 | 6 |
| 180 | 90 | 25 | 50 | 45 | 3600 | 200 | 400 | 18 | 27 | 4 | 6 |

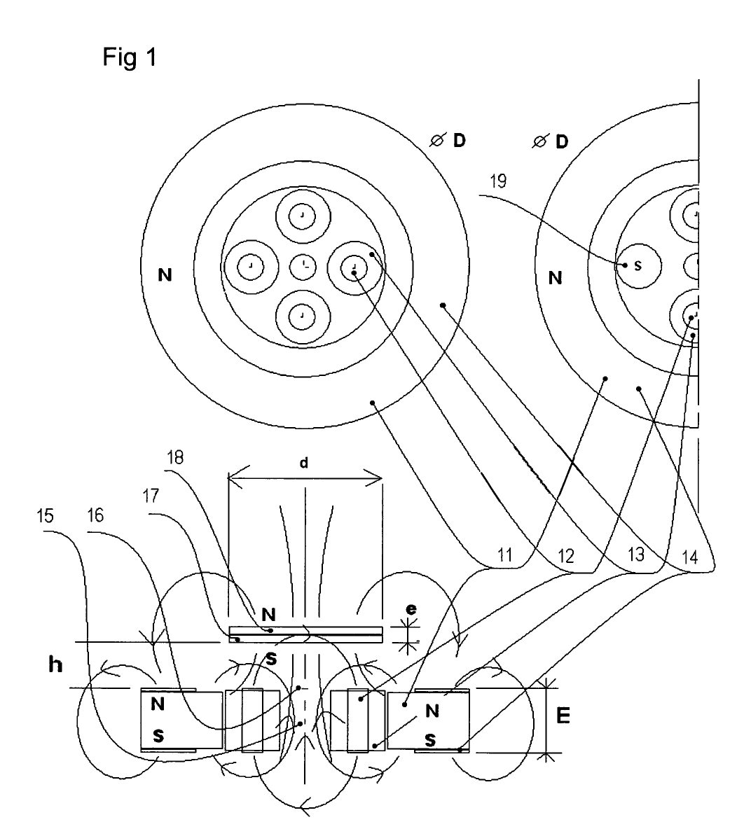

FIG. 1 describes this. It is based on a ring ferrite magnet 11 with external diameter D; internal diameter d; thickness E, with 2 flat rings iron 14, almost 2 iron cores 12 and copper coil 13, 2 levitated neodymium iron bore magnets 17 and 18, and 2 hall effect sensors 15 and 16. E′ represents the overall thickness of the levitator's base.

According to the invention, and due to its central position; the sensor 15 detects the position of the levitating magnets 17 and 18 but not the field of the coils 12, 13. Then sensor 15 drives an electronic slave system that's compensates the horizontal instability.

According to another version of the invention, 2 coils 12, 13 may be replaced with 2 magnets 19, this stabilises one of the 2 instable horizontal axes.

According to the invention the sensors 15 detects the horizontal contribution of the magnetic field emitted by the levitating magnet. This contribution is proportional to the drift of the levitating magnet over the base. The electronic slave system drives a current in the coils 13 in order to pull back the magnet 17, 18 over the centre; where the horizontal contribution of the magnetic field is null.

The experience demonstrates that the levitation distance and the control of the levitation is optimised in respect with a few relations:
d=D/2; E=D/10 e=E/2
then the levitation distance and control reaches h=D/4

In fact if E increases; then the levitation distance h is reduced. If e is increased, then the levitation distance h is reduced.

For this distance of levitation, the experience demonstrates that the requested power for setting up the levitating magnets over the base is almost the same what ever is the size of the base. Only the choice of 2 coils and 2 magnets or 4 coils has an influence. The magnetism and electromagnetism compared to weight is independent of the scale. Magnetic forces divided by weight is a number with no specific unit, means this ration is not dependant of the scale.

By the same, the power requested to set up the levitation is not dependant of the scale.

The consequence of this is:

The price of the solution is almost proportional to D³ for big devices. Means the quantity of material used for the magnets and the coils.
And for small device the price depends also from D³ but also from the price of the power supply and the price of the electronic board.

The best price of Neodymium Iron Bore magnet is 0.2 Usd per cm³. The best price of the ferrite magnet is around 0.5 cent USD per cm³ .
The best price of copper for the copper is 9 USD per kg;

For example, the cost for D=180 mm and 4 coils is 3.5 Usd for ferrite magnet, 3 Usd for copper; 12 Usd for neodymium iron bore magnet, and 3 Usd for switching power supply able to deliver 27 W during a short time; 1.4 USD for electronic board.

This means almost 23.5 USD for basic bill of material not including structure and wires and all accessories.

For a small one axe stabilised D=90 mm; the ring ferrite magnet is 0.3 Usd; the 2 copper coils are 0.52 Usd; 2.2 Usd for neodymium iron bore magnets and 3 Usd for switching power supply able to deliver 27 W during a short time; 0.7 USD for electronic board.

This means around 6.5 USD for the basic bill of material.

For a small 2 axe stabilised D=90 mm; the ring ferrite magnet is 0.3 Usd; the 2 copper coils are 1 Usd; 1.6 Usd for neodymium iron bore magnets and 3 Usd for switching power supply able to deliver 27 W during a short time; 1.4 USD for electronic board.

This means around 7.3 USD for the basic bill of material.

Of course these costs are given as a comparison but not as a reference.

### DESCRIPTION OF THE INVENTION

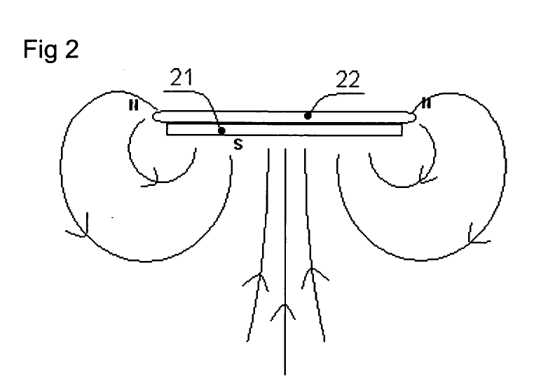

According to the invention FIG. 2 the price of the levitating item is optimised thanks to the use of a combination of a magnet 21 and a pure Iron or magnetic Iron alloy like an iron silicon disk 22.

According to the invention the optimised thickness of the iron is near e/2.

The cost or iron is near a tens of the cost of the magnet; in consequence the combination of the magnet and the iron has a cost that represent 0.6 of the cost of a magnet only solution.

For example, for a levitating device with D=180 mm; the cost is immediately and significantly reduced of 5 USD.

The iron represents a shortcut for the magnetic field, or a mirror.
Two magnets 17 and 18 stick together emit the same magnetic field as one only stick under a bigger iron disk.

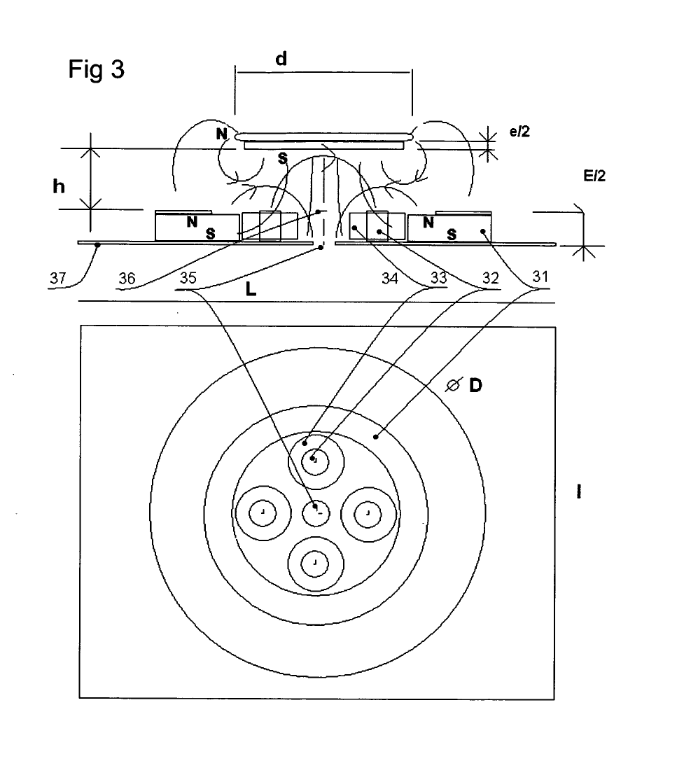

According to the invention; FIG. 3, an iron plate 37 realises a magnetic mirror for the magnet 31; the and the coil and core 31 and 32.

The optimised iron plate thickness is around E/10; and it is made in pure iron, or special magnetic iron alloy like iron silicon.

According to the invention; the iron plate 37 does not realise a mirror for the magnetic lines that reach the sensor 35 and 36. In fact the magnetic fields direction is fixed perpendicular to the surface of the mirror.
This means the tangential magnetic field is cancelled at the surface of a magnetic mirror.

According to the invention the levitating magnet position is detected thanks to the horizontal contribution of the magnetic field by the sensor 15 or 35.

According to the invention there is no magnetic minor around the sensor 35; in order that the horizontal contribution of the magnetic field of the levitating magnet is not cancelled and varies according to the position of the levitating magnet.

According to the invention; the sensor 15 is in the centre of a hole of the magnetic to mirror; where no field emitted by the coils 32 33 can reach it.

According to the invention; the magnetic minor used to optimise the magnetic efficiency of the ring magnet 31 and the coils and cores 32 33; has a hole in the centre where the sensor detect the position of the levitated magnet and iron 21 22.

Another way to summary this is that the iron or iron silicon plate is a minor for the ring magnet and the coil but not for the sensor and the levitated magnet. According to the invention, the optimised iron plate thickness is around E/10.

The magnetic field of the coil 32 and 33 avoids the hole and over pass it.

The consequence of this; are that this combination of magnet electromagnet and iron or iron silicon has exactly the same behaviour as the one described figure one, but.
Thickness and weight and of
   the ring magnet 31
   the coil and core 32
are divided by 2

By the same the power requested to setup the levitation is also divided by 2 because for the same current generating the same field inside the half coil; the voltage of the half coil is divided by 2. This means the efficiency of the coils is doubled.

Then as the consequence; it become possible to use a linear power supply that deliver power up to 10 W despite of switching power supply that become economically more attractive over 10 W.

In fact a linear power supply using a voltage transformer and diode bridge and capacitor and regulator; can deliver during a short time over power, but average must respect some limit imposed by the size of the transformer.

Means for average power under 4 W short time peak power 15 W may easily be to reached with no danger with a linear power supply of cost under 1 USD.
Then the thermal protection must be a combination of short term over power; over 20 W for example, and long term; under 10 W.
Then as a consequence; an average power supply of 4 W may become very cheap to dissipate; in the main electronic board. Over 5 W average power it is necessary to dissipate the electronic over heating in aluminium.

Under 5 W; it becomes possible to dissipate the heat thanks to the iron plate; with no additional cost. By the same the heat of the copper coil and the iron core is also easily dissipated in the iron plate.

For example, the cost for D=180 mm and 4 coils is 2 Usd for ferrite magnet, 1.5 Usd for copper; 6 Usd for neodymium iron bore magnet, and 1 Usd for linear power supply able to deliver 15 W during a short time; 1.4 USD for electronic board; and 1 USD for iron plate.

This means almost 13 USD for basic bill of material not including structure and wires and all accessories.

For a small one axe stabilised D=90 mm; the ring ferrite magnet is 0.2 usd; the 2 copper coils are 0.25 Usd; 0.6 Usd for neodymium iron bore magnets and 1 Usd for linear power supply able to deliver 15 W during a short time; 0.7 USD for electronic board. 0.5 USD for the iron.

This means around 3.15 USD for the basic bill of material.

For a small 2 axe stabilised D=90 mm; the ring ferrite magnet is 0.2 Usd; the 2 copper coils are 0.5 Usd; 0.6 Usd for neodymium iron bore magnets and 1 Usd for linear power supply able to deliver 15 W during a short time; 1.4 USD for the electronic board. 0.5 USD for the iron plate.

This means around 4.2 USD for the basic bill of material.

### CONCLUSION

The use of a magnetic mirror made of pure iron or of magnetic alloy like silicon alloy allow a reduction of the cost from
23.5 USD to 13 USD
for D=180 mm levitator 2 axis stabilised means 45% reduction cost.
6.5 USD to 3.15 USD
for D=90 mm levitator one axis stabilised means 50% reduction cost
7.3 USD to 4.2 USD
for D=90 mm levitator 2 axis stabilised means 42% reduction cost and around 40% reduction of the weight, of the heat; of the power requested, of the magnet thickness
and a dramatic reduction of the whole base thickness.

| | | | | | base | globe | Levitated | set up | set up | for turning | for turning |
|---|---|---|---|---|---|---|---|---|---|---|---|
| D | | | | | weight | size | weight | one axe | 2 axes | one axe | 2 axes |
| mm | d | E | E′ | h | g | mm | g | W | W | W | W |
| 90 | 45 | 15 | 15 | 25 | 400 | 100 | 60 | 6 | 9 | 1.5 | 3 |
| 120 | 60 | 15 | 15 | 30 | 800 | 140 | 120 | 9 | 14 | 1.5 | 3 |
| 180 | 90 | 20 | 20 | 45 | 1800 | 200 | 400 | 9 | 14 | 1.5 | 3 |

As a consequence of the invention; the base is not affecting any more the environment and may be used near a computer or a television, thanks to the trap of the magnetic field of the base's magnet.

The environment is not affecting the behaviour of the base, because the magnetic lines of the magnet and electromagnet are trapped inside iron alloy.

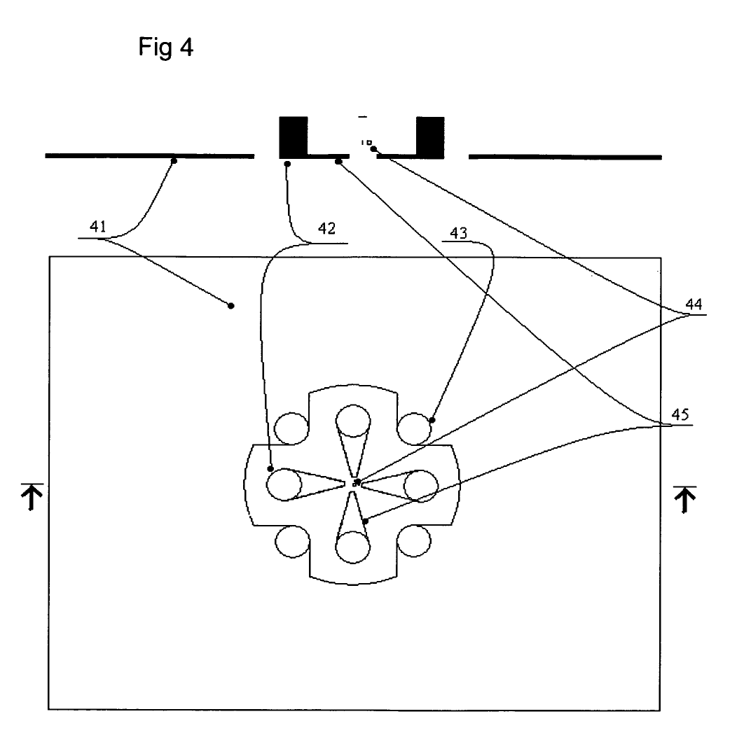

FIG. 4 describes the most efficient realisation of the invention.

For a question of clear understanding of the drawing FIG. 4; the ring magnet and the copper coils are not represented. Only the iron parts are represented.

The iron mirror 41 reflects the ring magnet field and the field are also guided inside the iron cores 43. By this way almost no field from the magnet cross the mirror 41 level.

The iron cores 42 and the iron part 45 traps the magnetic field and reduces the air gap to the minimum. By this way; the magnetic field of coil does not cross the mirror level and because of the very short air gap it is increase by a factor 2.

The horizontal field contribution of the levitating magnet is also trapped into the cores 42 and iron parts 45; and because the air gap is reduced this field is also increased around the sensors.

Then also; the sensors 44 best position is over the part 45; at a place where the magnetic field of the coil is cancelled.

The adjustment of the position of the part 45 allows cancelling completely the magnetic field of the coils on the sensors 44.

What is claimed is:

1. A device to produce magnetic levitation, comprising:
a base; and an item wherein the item levitates over the base in a stable arrangement without turning over,
wherein the item is positioned entirely above the base, and the base is configured to be entirely under a group of two parallel horizontal planes that are separated by a distance.
wherein the base is electrically operated by a lower power electric converter.
wherein the item turns on one of a vertical and a tilted axis.
wherein the base comprises at least one permanent lifting magnet distributed in a crown having an approximately cylindrical symmetry
wherein the item has a magnet with a field with a cylindrical symmetry at least when the base does not have a cylindrical symmetry.
wherein the magnets of the item are directed such that a magnetic field produced by the magnets pushes against an arrangement of magnets in the base an amount exactly equal to a weight of the item at a specific height.
wherein the magnets of the item are stable in rotation around a horizontal axis to ensure a stable orientation of the item.
wherein the magnets of the item are unstable in translation along at least one axis but stabilized by a control device, wherein the control device has a number of sensors as a number of axes of instability,
wherein the sensors measure a displacement of a center of gravity of the item along the axes of instability relative to the base and the control device has at least as many independent processing circuits as the number of axes of instability, driven from signals from the sensors that control current to the magnets configured as electromagnets and at least as many independent windings as the number of axes of instability forming the electromagnets that generate the magnetic fields,
wherein the magnetic fields generated corrections for displacements of the item to bring the item back to an equilibrium point by acting on the magnets of the item.
Wherein the sensor delivers a signal essentially proportional to a variation of a position of the item compared to an axis of the base, wherein the sensor is a magnetic sensor for a probe measuring the Hall Effect.
Wherein the sensor measures the horizontal contribution of the magnetic field of the items magnet
Wherein the sensor's position of the sensor is in the centre of the base where the magnetic field of the coil is cancelled
Wherein the efficiency the cost and the volume of the magnet and electromagnets is optimised by a factor 2 and the power supply requested is reduced by a factor 2 thanks to the combined use of an horizontally asymmetric iron structure that traps the field made of:
A ferromagnetic alloy disk over the item magnet
A ferromagnetic alloy disk under the base magnet; that realises a magnetic mirror; with a hole in the centre around the coils
2 iron parts under the coils that trap the field
The sensors in the centre and near the plane of the ferromagnetic board where the coil's field is cancelled.
